(19) United States
(12) Patent Application Publication
(10) Pub. No.: US 2018/0052235 A1
(43) Pub. Date: Feb. 22, 2018

(54) Optical Navigation for Underwater Vehicles

(71) Applicant: SPAWAR Systems Center Pacific, San Diego, CA (US)

(72) Inventors: Michael H. Tall, San Diego, CA (US); Walter C. Velasquez, Chula Vista, CA (US); Brandon J. Wiedemeier, San Diego, CA (US)

(73) Assignee: United States of America as represented by the Secretary of the Navy, San Diego, CA (US)

(21) Appl. No.: 15/239,090

(22) Filed: Aug. 17, 2016

(51) Int. Cl. G01S 17/89; H04N 5/225; G01S 7/481; G01S 17/93

(52) U.S. Cl. CPC G01S 17/89; H04N 5/2252; B63B 2211/02; G01S 17/93; G06T 2207/30252; G01S 7/4813

(57) ABSTRACT

An optical navigation system and method for underwater vehicles. The system is disposed within a pressure housing to protect the system's components from high pressures at depths as great as the ocean's floor. The system includes an optical sensor that takes multiple images, e.g., an ocean floor, through a sensor lens. A light source produces a light beam that is offset from the sensor lens. The light source reflects light directly into the field-of-view of the sensor, e.g., on the ocean floor. Software is stored in memory resident within the housing. The software determines the offset of features between at least two images taken with the sensor. Navigation information derived from these images may include a vehicle's two-dimensional position.

### STATEMENT OF GOVERNMENT INTEREST

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619)553-5118; email: ssc.pac.12@navy.mil. Reference Navy Case No. 103,105.

### BACKGROUND OF THE INVENTION

### Field of Invention

This disclosure relates to optical navigation and, more particularly, to optical navigation for underwater vehicles.

### Description of Related Art

Underwater navigation presents challenges for vehicles. Underwater navigation is not feasible for a typical global positioning system (GPS) as these systems cannot operate underwater. The radio frequency signals that are typically necessary for GPS are attenuated by water. Therefore, the location of an underwater vehicle may not be known until the vehicle resurfaces for GPS navigation or visual confirmation. Accordingly, a means to track location between known points is required for location accuracy. Given the current availability of navigation tools for underwater use, the cost has been prohibitive for many uses. When an underwater vehicle submerges, location metrics such as from GPS and other communication methods are lost. At this point, the underwater vehicle must rely on onboard sensors to maintain location accuracy.

Prior art methods for underwater navigation include using an Inertial Measurement Unit (IMU), Doppler Velocity Log (DVL), or acoustic communication with surface floats or subsea clumps. The cost of these sensors can be on the order of at least tens of thousands of dollars. In addition, these sensors are delicate and subject to damage, and may require active logistics support to accomplish the task via surface or underwater reference locators. Typical additional costs when acquiring and adapting the above-mentioned devices include customizing proprietary programming, non-recurring engineering cost associated with feature implementation, and support hardware.

In addition, an IMU is very sensitive to shock and may not be reliable. A DVL works through acoustic means and may be sensitive to fouling as its sensors are exposed to seawater. IMUs and DVLs also don't report position, so their solution needs to be integrated with respect to time, so even the highest end sensor will experience navigation “drift”. Other acoustic means using known reference sources are limited by range, are noisy (not covert) and require a lot of energy.

Computer mouse technology is well proven and accurate for local telemetry and is achieved for a very low cost. Therefore, it should be considered for underwater telemetry. It is very robust with high reliability, and can be made easily programmable through commonly available means. It works by performing image processing algorithms to determine the offset of features between multiple images taken with the mouse's optical sensor. It typically uses a standard LED or laser in the red-to-infrared spectrum to illuminate a scene. The return images are retrieved through a set focal length lens. When a surface is within close proximity (approximately 0-6 inches), LED is sufficient to illuminate the surface and the sensor can achieve high accuracy tracking.

Though the sensor is capable of taking measurements with ambient light, it can be shown that the accuracy diminishes with lower light conditions. By using a laser or other light source, the measurement field can be illuminated such that the sensor can more easily detect differences in the images and track movement. Because a laser can focus on a given point on the measured surface (hereafter called “ground”), given the proper lens geometry, the sensor can track telemetry in a similar manner to its more conventional desktop use.

The typical mouse sensor has a near focus, narrow field of view lens that is physically very close to the light source and the ground. This geometry is preserved in its application because the sensor and light source are always at a constant distance from the ground (i.e. the mouse is physically on the ground). This, however, is impractical for underwater navigation as the ground is very seldom flat.

There is a need for incorporation of a low-cost mouse sensor into a system for low-cost optical navigation for underwater vehicles. This new system should address the aforementioned shortcomings of using a mouse sensor system that was designed for a computer.

### BRIEF SUMMARY OF INVENTION

The present disclosure addresses the needs noted above by providing an underwater vehicle and method for underwater navigation. In accordance with one embodiment of the present disclosure, the underwater vehicle is capable of operating within close proximity to an underwater ground. The underwater vehicle includes an optical navigation system. The optical navigation system comprises a pressure housing that includes, disposed within the pressure housing: a sensor capable of taking images; a light source configured to produce a light beam that is offset from the sensor lens. The light source is further configured to reflect light directly into the field of view of the sensor. The navigation system also includes a processor, operably coupled to the sensor. The processor is configured to execute instructions. A memory, operably coupled to the processor and sensor, stores processor-executable instructions and images taken with the sensor. When executed, the instructions cause the processor to determine the offset of features between at least two images taken with the optical sensor. The instructions cause the processor to determine a distance traveled based on the offset between the at least two images.

These, as well as other objects, features and benefits will now become clear from a review of the following detailed description, the illustrative embodiments, and the accompanying drawings.

### BRIEF DESCRIPTION OF DRAWINGS

The accompanying drawings, which are incorporated in and form a part of the specification, illustrate example embodiments and, together with the description, serve to explain the principles of the invention. In the drawings:

FIG. 1 illustrates an underwater vehicle and an optical navigation system in accordance with one embodiment of the present disclosure.

FIG. 2 illustrates an exploded view of components of a system for optical navigation of underwater vehicles, in accordance with one embodiment of the present disclosure.

FIG. 3A illustrates an exterior view of the system in FIG. 2 optical navigation of underwater vehicles, in accordance with one embodiment of the present disclosure.

FIG. 3B illustrates a cross-sectional view of the system for optical navigation of underwater vehicles, in accordance with one embodiment of the present disclosure.

### DETAILED DESCRIPTION OF THE INVENTION

The optical navigation system and method disclosed herein achieve two-dimensional (2D) navigation telemetry for underwater vehicles by leveraging open source programming and low cost commercial off-the-shelf (COTS) technology.

Disclosed herein is an underwater vehicle with an optical navigation system that is disposed within a pressure housing. Also disclosed herein is a method for optical navigation for underwater vehicles. The optical navigation system and method include a sensor that takes images of an ocean floor or other underwater ground, through a sensor lens. A light source produces a light beam that is offset from the sensor lens. The light source reflects light directly into the field-of-view of the sensor. The field of view may feature the ocean floor. The sensor takes multiple images which are received by software that is stored in memory that resides within the housing. The software, which may be feature detection software, is executable by a processor. When executed, the software causes the processor to determine the offset of features between at least two images taken with the sensor. In this manner, navigation information may be derived. This navigation information may include a vehicle's two-dimensional position, especially when a compass is used for a fixed reference. In addition, for underwater vehicles, the information could include surge (front-back motion) and sway (side-to-side motion) which may occur as a result of wave motion. The optical navigation system disclosed herein could be adapted for use with land vehicles.

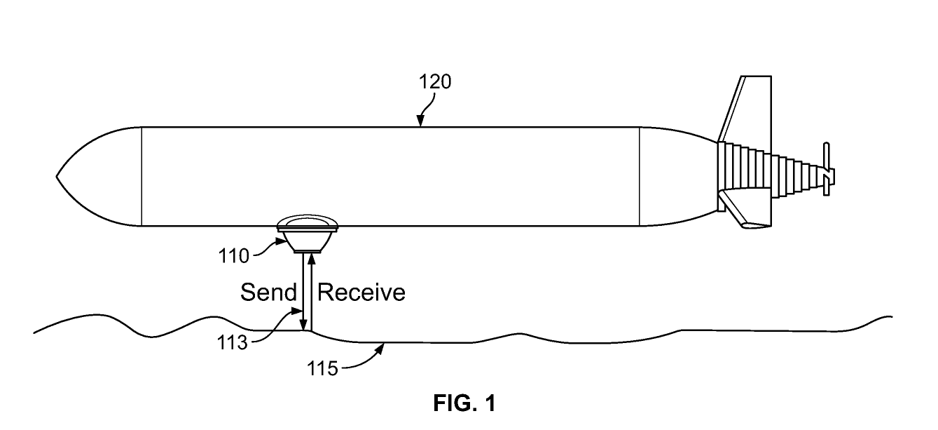

Referring now to FIG. 1, illustrated is an underwater vehicle to which the optical navigation system has been attached. The optical navigation system 110 is mounted to the underside of underwater vehicle 120. In lieu of the underwater vehicle 120 shown in FIG. 1, the optical navigation system 110 may be used with other underwater vehicles. For example, autonomous underwater vehicles may be used to perform underwater survey missions. The missions may include detection and mapping of obstacles that pose a hazard to navigation for water vessels. These obstacles may include debris, rocks and submerged wrecks. Other underwater vehicles may be manned, e.g., vehicles transporting scientists for exploratory purposes. Numerous other examples exist for underwater vehicles or other objects or bodies that can be used with the present disclosure. The vehicle, other object or person needs to be capable of operating underwater within close proximity to underwater ground, or the water's floor.

The optical navigation system 110 may take images of the ocean floor. Based on those images, the system 110 can determine the two-dimensional position of underwater vehicle 120. The optical navigation system 110 can also determine surge motion has occurred based on how far front and/or back at least one of the images is from at least one other image. The optical navigation system 110 can determine how much sway motion has occurred based on how far sideways at least one of the images is from at least one other image.

As shown in FIG. 1, light beam 113 is emitted from the optical navigation system 110 via a light source (not shown) that is resident within the housing of the optical navigation system 110. The light from light beam 113 is then reflected from the underwater ground 115 which, in this embodiment is a sea floor. The light is then received back into the optical navigation system 110 via a camera resident within the optical navigation system 110.

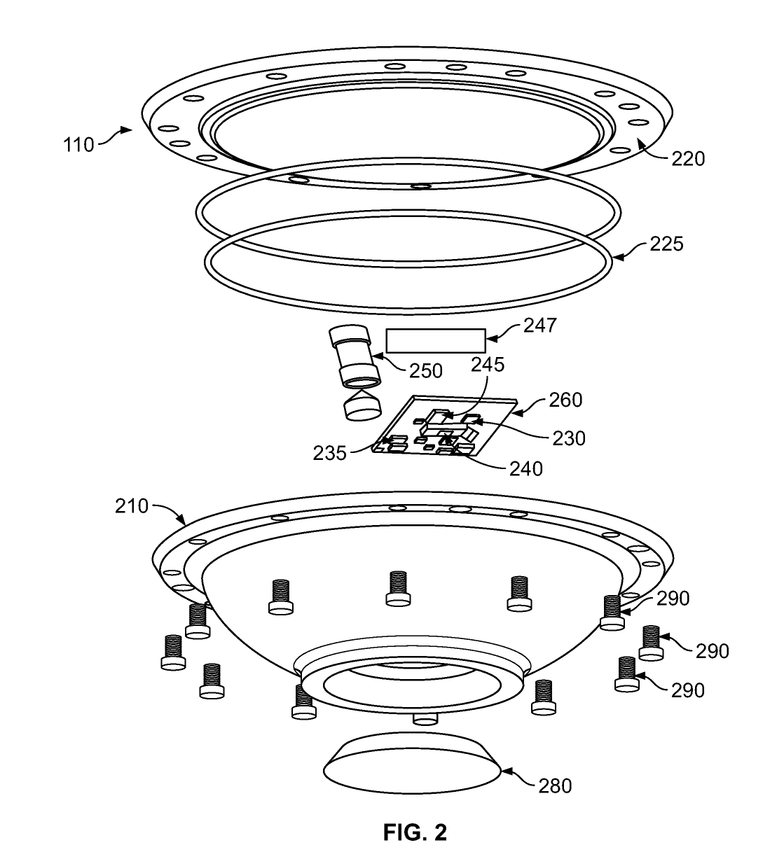

Referring now to FIGS. 1 and 2 together, the optical navigation system 110 includes a watertight pressure housing that includes a pressure body 210 and a pressure lid 220 to contain the elements of the optical navigation system 110. The pressure body 210 and a pressure lid 220 may include a watertight seal provided by O-ring 225. Multiple O-rings such as O-ring 225 may also be used.

Disposed within the pressure body 210 are an optical sensor 230 and a sensor lens 240. The optical sensor 230 is capable of taking images through sensor lens 240, and thus the line of sight of optical sensor 230 should be directed through sensor lens 240. Optical sensor 230 may be a complementary metal-oxide-semiconductor (CMOS) sensor, an N-type metal-oxide-semiconductor (NMOS), a semiconductor charge coupled device (CCD) sensor or other sensor capable of taking digital images or capable of converting reflecting light back to a digital signal.

Still referring to FIGS. 1 and 2 together, lens 240 may be a typical single lens reflex (SLR) lens with differing focal lengths. Lens 240 may be used to focus light reflected back into optical sensor 230 based on the distance of the optical navigation system 110 from underwater ground 115. For purposes of the present disclosure, underwater ground 115 may include the bottom of an ocean or a sea, or a manmade body of water through which an underwater vehicle may travel. In the present illustration, underwater ground 115 is the sea floor. It may also be possible to implement the optical navigation system 110 without lens 240 where a laser beam is used for light source 250. When light beam 113 is emitted from a laser as light source 250, the emitted light may already be focused.

Still referring to FIGS. 1 and 2 together, light source 250 produces a light beam 113 that may be offset from the sensor lens 240. Light source 250 may be a standard LED or a laser in the red-to-infrared spectrum that illuminates the underwater ground 115, or sea floor. When underwater ground 115 is within close proximity to light source 250, a light emitting diode (LED) may be sufficient to illuminate the underwater ground 115 and the optical sensor 230 can achieve high accuracy tracking. Close proximity to underwater ground 115 may mean as little as approximately zero to six inches (0″-6″), and in some cases, as much as zero to eighteen inches (0″-18″). The light source 250 is positioned to reflect light directly into the field of view of the optical sensor 230. In one example, the field of view may be thirty degrees (30°). The farther from the underwater ground 115 the light source 250 is positioned, the more distance covered by the field of view.

Still referring to FIGS. 1 and 2 together, the optical sensor 230 is capable of taking measurements with ambient light. However, accuracy may be diminished with lower light conditions. If the optical sensor 230 incorporates a laser as light source 250, the measurement field can be illuminated such that the optical sensor 230 can more easily detect differences in the images and track movement. Because a laser can focus on a given point on underwater ground 115, given the proper lens geometry, the optical sensor 230 can track telemetry in a similar manner to its more conventional desktop use.

Still referring to FIGS. 1 and 2 together, though light source 250 need not be a laser, a laser may be more effective for longer distances between the optical sensor 230 and ground 115. Using a laser may minimize the illuminator's projection on the medium, thus minimizing backscatter. Wavelengths for light source 250 can be chosen such that backscatter from the water particulates are minimized, and less power is required to achieve high local illuminance values. As a general matter, higher wavelengths may tend to attenuate more and scatter more in sea water. Lasers with wavelengths in the green spectrum may work well in the water because they may propagate through the water. However, it should be considered whether green may propagate too well and be too light for the sensor 230. Lasers having wavelengths in the red spectrum may also be a suitable fit. The power of the laser may also be taken into account in order to reduce attenuation in ways that are known in the art.

The ocean floor and other underwater ground areas are very seldom flat. Therefore, it may be desirable for the light source 250 and the optical sensor 240 to be on the same optical path. Ideally, when using a laser, the line of sight of the optical sensor 230 should be on the same axis as the beam path of the laser to eliminate any errors due to parallax. Parallax is a displacement or difference in the apparent position of an object when the object is viewed along two different lines of sight. Parallax may be measured by the angle or semi-angle of inclination between those two lines.

Light source 250 may be made to travel directly through the sensor lens 240 (bore sighting), or it may be mounted at a minimum slight offset, so that it can reflect light directly in the field of view of the optical sensor 230. If the light is made to travel directly through the sensor lens 240, this has the advantage of zero parallax so that distance is not an issue for alignment, only illuminance.

The sensor lens 240 may have a wider field of view or a larger depth of field to maintain low sensitivity to varying height. Two-dimensional (2D) telemetry is taken with the optical sensor 230 and calibrated through compass readings. A compass (not shown in FIG. 1) may be provided onboard the underwater vehicle 120. Commercially available compasses, which are cheap and robust, may be used to provide a fixed reference frame, including north, south, east and west coordinates. Thus, the compass may give a fixed geographical position for the underwater vehicle 120. The compass may also include rotation, pitch and yaw data for further accuracy. The compass (not shown in FIG. 2) may be operably coupled to the processor 245 and optical sensor 230.

Circuit board 260 includes a processor 245 that is operably coupled to the optical sensor 230. Processor 245 may be a digital signal processor. A power source 247, e.g., a battery, may provide power to the optical sensor 30, processor 245, light source 250 and other components needing power. Circuit board 260 also includes a memory 235 that stores processor-executable instructions as well as images taken with the optical sensor 230. Processor 245 should be of sufficient speed to process images and instructions for the optical navigation system 110 at the rate needed in order to determine image offsets at the rate necessary to accomplish 2-D navigation. Images of underwater ground 115 may be captured in continuous succession and compared with each other in order to determine how far the underwater vehicle 120 has moved. Memory 235 or other data storage medium should be of sufficient size to store multiple images over at least the course of a trip for the underwater vehicle. Memory 235 is operably coupled to processor 245. When executed, the instructions in memory 235 cause the processor 245 to determine the offset of features between at least two images taken with the sensor 230. Features may include any identifiable characteristic in the image, including any change in pixel. The features may include rocks, aquatic plants, changes in elevation, and any other feature that can translate to an identifiable pixel. Features can even be naked to the human eye, such as a multiple lighter colored pieces of sand next to multiple slightly darker colored pieces of sand. The features may also include different textures on the underwater ground 115 or sea floor.

A window 280 is disposed within the watertight pressure housing. Window 280 is configured to receive light emitted from the light source to the underwater ground 115. The window 280 is further configured to receive light reflected back from the underwater ground 115 to a field of view of the optical sensor 230. Bolts 290 or other securing means may secure the pressure lid 220 to the pressure body 210.

Optical sensor 230 may be chosen, at least in part, based on its frame rate. The frame rate needed for optical sensor 230 may depend on the speed of the vehicle or other body on which the optical sensor 230 is mounted.

The frame rate needed for the optical sensor 230 may be determined according to the following equation:

$$( 100 \% - β ) [ 2 * tan \frac{θ}{2} * H ] * FPS > V \qquad ( Equation 1 )$$

θ=FOV of optical sensor
β=% frame overlap needed for Digital Image Correlation (DIC)
H=height of optical sensor from reflecting surface
FPS=Frames per second of optical sensor
V=velocity of vehicle.

The return images may be received via sensor lens 240, which may have a set focal length.

Digital image correlation and tracking and/or image processing algorithms may be used to determine the offset of features between multiple images taken with the optical sensor 230. Digital image correlation and tracking is an optical method that uses tracking and image registration techniques for accurate two-dimensional and three-dimensional measurements of changes in images. An example of a digital image correlation technique is cross-correlation to measure shifts in data sets. Another example of a digital image correlation technique is deformation mapping, wherein an image is deformed to match a previous image.

Feature detection algorithms are an example of the type of image processing algorithm that may be used. Feature detection algorithms are known in the art. Examples of feature detection algorithms can be found in the following publication: Jianbo Shi and C. Tomasi, “Good features to track,” Computer Vision and Pattern Recognition, 1994. Proceedings CVPR '94., 1994 IEEE Computer Society Conference on, Seattle, Wash., 1994, pp. 593-600.

Some feature detection algorithms receive an image, divide it into segments and look for features, texture and surfaces as markers. For example, if a camera zooms in to a small square, e.g., a sandy bottom, pixels will show distinctions between portions of the sandy bottom. Markers such as these may be compared in subsequent images to see how far a vehicle has traveled. Memory 235 may also be operably coupled to a compass (not shown in FIG. 2) onboard the underwater vehicle so that the memory 235 receives data from the compass. In this manner, the compass data may be used to provide an absolute position for the underwater vehicle.

Still referring to FIGS. 1 and 2 together, The distance traveled can be determined based on the focal length of the optical sensor 230. If the height of sensor 230 in relation to underwater ground 115 is fixed, and the optical sensor 230 outputs pixels, the pixels could be converted to a value in feet or inches. The distance traveled will depend on how high the optical sensor 230 is from underwater ground 115. If there are known data points as far as height, then the distance traveled can be extrapolated/interpolated based on that known data. For example, at twelve inches (12″) from underwater ground 115, a ten-pixel movement may translate to three inches (3″) of travel. Therefore, this data can be interpolated so that a twenty-pixel movement may translate to six inches (6″) of travel.

Also by way of example, if we know what the distance traveled would be if we were six inches (6″) from underwater ground 115 and eight inches (8″) from underwater ground 115, we may be able to interpolate that data to reach a conclusion as to distance traveled if we were seven inches (7″) from underwater ground 115. Generally, the closer to the water's floor, the less the vehicle has traveled. Feature detection algorithms, which may be obtained as COTS items, take information such as this into account.

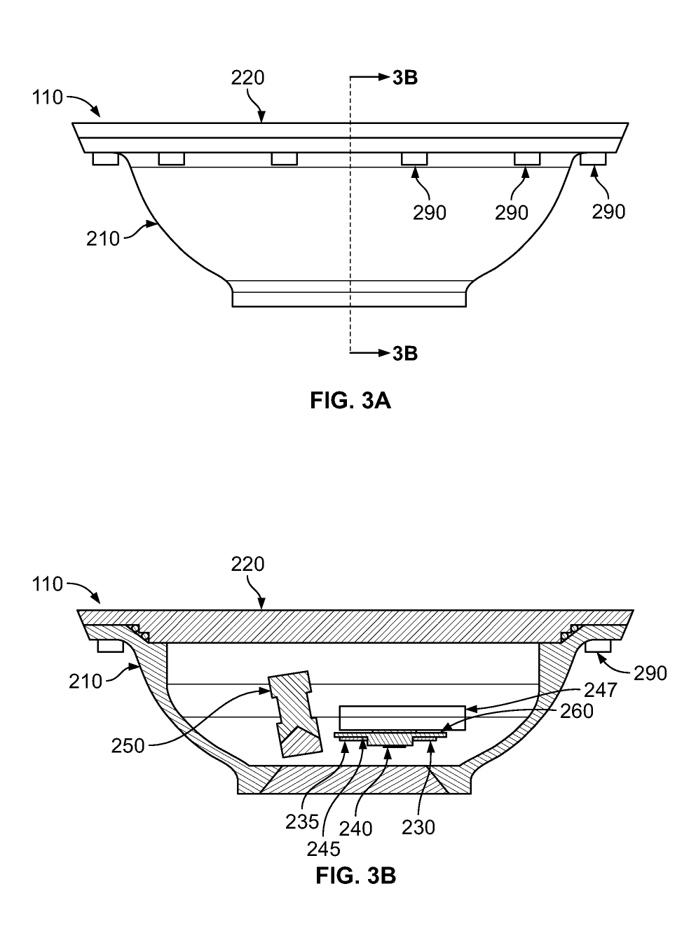

Referring now to FIGS. 3A and 3B together, FIG. 3A illustrates an exterior view of the optical navigation system, while FIG. 3B illustrates a cross-sectional view of the optical navigation system. As shown in FIGS. 3A and 3B together, optical navigation system 110 includes a pressure body 210 and a pressure lid 220. Bolts 290 or other securing means may secure the pressure lid 220 to the pressure body 210. On the interior of pressure body 210 and pressure lid 220 may reside the sensor 230, memory 235, sensor lens 240, processor 245, light source 250 and circuit board 260. Pressure body 210 and pressure lid 220 aid in keeping internal components sensor 230, memory 235, sensor lens 240, processor 245, light source 250, and circuit board 260 protected from the pressure that can occur at significant subsea depths. Such pressures may be particularly strong near a sea floor or ocean floor.

Circuit board 260 and light source 50 may be mounted onto the interior of pressure body 210, or otherwise disposed within pressure body 210, using a number of means known in the art, including hard mounting, brackets, and foam. Mounted on circuit board 260 may be sensor 230, memory 235, sensor lens 240, processor 245 and power source 247 (e.g., a battery).

When used underwater, it is the intention of this system to work where measurement can be taken close to the ground. Because of optical challenges with visibility and backscatter due to turbidity, distances of less than a meter from ground are expected for subsea use. However, this technology could be adapted as an alternative navigation source to any vehicle traveling over ground where the distance is known such as land vehicles.

Additionally it can be used where ambient light can be utilized for image processing, and the distance can be taken as optical infinity, such as day use for aerial vehicles, or where ground lights can be used as the tracking points during night flight.

The invention can take on alternate embodiments. In this invention's first embodiment, ground refers to the sea floor, however it is not limited to this. Ship hull inspection, pipeline inspection, etc. could also apply. Also, for vehicles that require an operational depth that is not near ground, the user could modify their vehicle's mission to submerge near the seafloor, navigate a 2D position, then float up to its desired working depth.

Another embodiment could be for land survey or mapping utilizing the high accuracy of this system.

Another embodiment could be as a cheap alternative for land or air speed utilizing the low cost of this system to eliminate the lens of the laser, the sensor or both. Autofocus could be implemented to account for varying measurement distance. Multiple systems could be used in tandem to reduce error for turbid conditions. Different colored lasers or alternative light sources could be used based on mission conditions for better performance or covert operations.

The present system incorporates proven, reliable components such as circuit boards, sensors and lasers have proven to be very high. The system may be provided using COTS, easy to use items. The present system eliminates the requirement for acoustic measurements. Therefore, operation can be made active while still maintaining a covert signature to listening devices. Because it does not use acoustic devices, the system has a comparatively lower energy cost.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. An underwater vehicle capable of operating within close proximity to underwater ground, the underwater vehicle including an optical navigation system, the optical navigation system comprising:
a watertight pressure housing that includes, disposed within the pressure housing:
an optical sensor capable of taking images;
a light source configured to produce a light beam that is offset from a sensor lens, wherein the light source is further configured to reflect light directly into a field of view of the optical sensor;
a processor, operably coupled to the optical sensor, wherein the processor is configured to execute processor-executable instructions;
a memory, operably coupled to the processor and the optical sensor, that stores the processor-executable instructions and images taken with the optical sensor, wherein when executed, the instructions cause the processor to determine an offset of features between at least two images taken with the optical sensor, and wherein the instructions cause the processor to determine a distance traveled by the underwater vehicle based on the offset between the at least two images.

2. The underwater vehicle of claim 1, wherein the light source is a laser light source.

3. The underwater vehicle of claim 1, further comprising:
a compass configured to provide an absolute position for the underwater vehicle.

4. The underwater vehicle of claim 1, further comprising:
a power source that is operably coupled to the optical sensor, the light source, and the processor.

5. The underwater vehicle of claim 1, wherein the watertight pressure housing further includes, disposed within the pressure housing, a window configured to receive light emitted from the light source to the underwater ground, the window being further configured to receive light reflected back from the underwater ground to a field of view of the optical sensor.

6. The underwater vehicle of claim 1, wherein the light source is bore-sighted through the sensor lens.

7. The underwater vehicle of claim 1, wherein the pressure housing includes a lid.

8. The system of claim 1, further comprising one or more O-rings configured to aid in providing a watertight seal for watertight pressure housing.

9. The underwater vehicle of claim 1, further comprising:
a sensor lens configured to focus reflected light back into the optical sensor.

10. The underwater vehicle of claim 1, wherein the optical navigation system is adapted to be fixedly attached to the underwater vehicle.

11. A method for optical navigation of an underwater vehicle, the method comprising:
providing an underwater vehicle capable of being sufficiently close to an underwater ground such that light from a light source can be reflected back to an optical sensor;
directing the light source to the underwater ground such that light is reflected back to a field-of-view for the optical sensor, wherein the optical sensor is fixedly attached to the underwater vehicle, and wherein the optical sensor is capable of taking images of the underwater ground;
taking, via the optical sensor, multiple images of the underwater ground;
storing, via a memory, the multiple images of the underwater ground and processor-executable instructions;
executing, via a processor that is operably coupled to the memory, instructions that cause the processor to determine an offset of features between at least two of the multiple images taken by the optical sensor; and
determining, via processor-executable instructions stored in the memory, a distance traveled by the underwater vehicle based on the offset of features between the at least two of the multiple images taken by the optical sensor.

12. The method of claim 11, wherein the light source is a laser light source.

13. The method of claim 11, further comprising:
providing a compass configured to provide an absolute position for the underwater vehicle.

14. The method of claim 11, further comprising the step of:
providing a power source that is operably coupled to the optical sensor, the light source and the processor.

15. The method of claim 11, further comprising:
providing a sensor lens configured to focus reflected light back into the optical sensor.

16. The method of claim 15, wherein the light source is bore-sighted through the sensor lens.

17. The method of claim 11, wherein the optical sensor, the light source, the memory and the processor are disposed within a watertight pressure housing.

18. An underwater vehicle capable of operating within close proximity to underwater ground, the underwater vehicle including an optical navigation system, the optical navigation system comprising:
a watertight pressure housing that includes, disposed within the pressure housing:
an optical sensor capable of taking images;
a laser light source configured to produce a light beam that is offset from a sensor lens, wherein the light source is further configured to reflect light directly into a field of view of the optical sensor;
a processor, operably coupled to the optical sensor, wherein the processor is configured to execute processor-executable instructions;
a power source operably coupled to the optical sensor, the laser light source and the processor;
a memory that is operably coupled to the optical sensor and processor, wherein the memory stores the processor-executable instructions and images taken with the optical sensor, wherein when executed, the processor-executable instructions cause the processor to determine an offset of features between at least two images taken with the optical sensor, and wherein the instructions cause the processor to determine a distance traveled based on the offset between the at least two images; and
a compass configured to provide an absolute position for the underwater vehicle based on a fixed reference frame.

19. The underwater vehicle of claim 18, wherein the watertight pressure housing further includes, disposed within the pressure housing, a window configured to receive light emitted from the light source to the underwater ground, the window being further configured to receive light reflected back from the underwater ground to a field of view of the optical sensor.

20. The underwater vehicle of claim 18, wherein the light source is bore-sighted through the sensor lens.
